(19) United States
(12) Patent Application Publication
(10) Pub. No.: US 2025/0224973 A1
(43) Pub. Date: Jul. 10, 2025

(54) Solution Composition And Decomposition

(71) Applicant: Google LLC, Mountain View, CA (US)

(72) Inventors: Ayush Jain, Bengaluru (IN); Prateek Jain, Bengaluru (IN); Martin Maly, Port Townsend, WA (US); Bhaskar Singhal, Bengaluru (IN); Ramakrishna Voruganti, Bangalore (IN)

(21) Appl. No.: 18/404,482

(22) Filed: Jan. 4, 2024

(51) Int. Cl. G06F 9/455

(52) U.S. Cl. CPC G06F 9/45512

(57) ABSTRACT

Aspects of the disclosed technology include techniques and mechanisms for solution composition and decomposition. A command line interface tool may receive a user command to add components to a solution. The command line interface tool may analyze metadata associated with the components to identify inter-component relationships. Based on determining the components have linked variable values, the command line interface tool may determine the components have an inter-component relationship and may automatically connect the components. Based on determining the components do not have linked variable values, the command line interface tool may generate recommendations for connecting the components.

### BACKGROUND

At least one method of designing application architecture includes utilizing an application composition tool configured to generate at least one solution. The solution may include at least one component, such as a command that is performed during execution of the solution. The application composition tool may receive, based on a user selection from a plurality of supported components, at least one component to be added to the solution. The user may modify the components that are added to the solution by, for example, connecting components, disconnecting components, removing components, defining variables associated with the components within the solution, or the like. In some instances, the application composition tool may generate, for the user, a source code template that corresponds to the solution and may allow for real-time modifications to the source code template.

However, the application composition tool might not provide connection suggestions between components. For example, the application composition tool might not be configured to identify possible connections that may be made between the components within the solution. Further, the application composition tool might not provide for auto-connecting the components within the solution. For example, the application composition tool might not be configured to identify the components within the solution that are most likely to be connected and to perform auto-connection of the identified components.

### SUMMARY

Aspects of the disclosed technology include methods, apparatuses, systems, and computer-readable media for solution composition and decomposition. For example, a command line interface tool may receive a user command to add components to a solution. Each component may have one or more variables, including input variables and output variables that may be defined via user input. The command line interface tool may analyze previously composed solutions to identify inter-component relationships therein. An inter-component relationship may indicate that at least two components are connected based on an output variable value of a first component being used to define an input variable value of a second component. Based on determining the components were connected in a previously composed solution, the command line interface tool may determine the components have an inter-component relationship and may automatically connect the components in the solution. Based on determining the components do not have an inter-component relationship, the command line interface tool may generate recommendations for connecting the components based on the analysis of the previously composed solutions.

One aspect of the disclosure provides for a command line interface tool for generating a solution comprising one or more components, the command line interface tool comprising one or more processors configured to: receive, from a user, an instance of a component; populate the solution with at least one module that supports the instance of the component; identify inter-component relationships comprising the instance of the component; and generate solution composition recommendations based on the identified inter-component relationships.

In the foregoing instance, the component comprises one or more solution composition files, wherein the one or more solution composition files comprise: a directory of one or more logically related resources used in the solution; a directory storing data that identifies providers of the one or more logically related resources; a directory of input variables to be defined in the solution; a directory of output variables to be defined in the solution; and a directory of data that corresponds to the inter-component relationships.

In one or more of the foregoing instances, defining the input variables and the output variables comprises receiving a user command identifying global variables, wherein a global variable has a same user-defined value across all components within the solution.

In one or more of the foregoing instances, defining the input variables and the output variables comprises receiving a user command identifying non-global variables, wherein a non-global variable has a unique user-defined value in each component within the solution.

In one or more of the foregoing instances, defining the input variables and the output variables is based on metadata within the one or more solution composition files, the metadata identifying values of the output variables of the component that are used as values of input variables of a second component.

In one or more of the foregoing instances, identifying the inter-component relationships further causes the one or more processors to: parse the one or more solution composition files comprising metadata associated with the component; and determine, based on the parsing, whether a second component is logically related to the component, the second component being logically related when the component and the second component have linked variable values.

In one or more of the foregoing instances, the one or more processors are configured to parse one or more directories comprising definitions of the component and the modules, wherein the definitions comprise one or more commands supported by the component.

In one or more of the foregoing instances, the one or more processors are configured to generate a graph that represents connections between two or more components, the graph comprising: nodes that represent the components; and edges that represent connections between the components.

In one or more of the foregoing instances, the one or more processors are configured to: receive, from the user, a command to remove an auto-connection between two or more components; and modify the solution based on the received user command.

In one or more of the foregoing instances, generating solution composition recommendations further causes the one or more processors to: parse one or more solution composition files comprising metadata associated with the component; identify a second component within the solution that is logically related to the component; and recommend that the component and the second component within the solution be connected.

Another aspect of the disclosure provides for a method for performing solution composition, the method comprising: receiving, by a command line interface tool and from a user, an instance of a component; populating, by the command line interface tool, the solution with at least one module that supports the instance of the component; identifying, by the command line interface tool, inter-component relationships comprising the instance of the component; and generating, by the command line interface tool, solution composition recommendations based on the identified inter-component relationships.

In the foregoing instance, identifying the inter-component relationships comprises: parsing, by the command line interface tool, one or more solution composition files comprising metadata associated with the component; and determining, by the command line interface tool and based on the parsing, whether a second component is logically related to the component, the second component being logically related when the component and the second component have linked variable values.

In one or more of the foregoing instances, the method further comprises parsing, by the command line interface tool, one or more directories comprising definitions of the component and the modules, wherein the definitions comprise one or more commands supported by the component.

In one or more of the foregoing instances, the method further comprises generating a graph that represents connections between two or more components, the graph comprising: nodes that represent the components; and edges that represent connections between the components.

In one or more of the foregoing instances, the method further comprises receiving, by the command line interface tool and from the user, a command to remove an auto-connection between two or more components; and modifying the solution based on the received user command.

Another aspect of the disclosure provides for a non-transitory computer readable storage medium storing instructions that, when executed by one or more processors for performing solution composition, cause the one or more processors to: receive, from a user, an instance of a component; populate the solution with at least one module that supports the instance of the component; identify inter-component relationships comprising the instance of the component; and generate solution composition recommendations based on the identified inter-component relationships.

In the foregoing instance, the component comprises one or more solution composition files, wherein the one or more solution composition files comprise: a directory of one or more logically related resources used in the solution; a directory storing data that identifies providers of the one or more logically related resources; a directory of input variables to be defined in the solution; a directory of output variables to be defined in the solution; and a directory of data that corresponds to the inter-component relationships.

In one or more of the foregoing instances, generating solution composition recommendations further causes the one or more processors to: parse the one or more solution composition files comprising metadata associated with the component; identify a second component within the solution that is logically related to the component; and recommend that the component and the second component within the solution be connected.

In one or more of the foregoing instances, defining the input variables and the output variables comprises receiving a user command identifying global variables, wherein a global variable has a same user-defined value across all components within the solution.

In one or more of the foregoing instances, defining the input variables and the output variables comprises receiving a user command identifying non-global variables, wherein a non-global variable has a unique user-defined value in each component within the solution.

### BRIEF DESCRIPTION OF THE DRAWINGS

FIG. 1A illustrates an example computing environment for performing solution composition and decomposition, in accordance with aspects of the disclosure.

FIG. 1B illustrates an example command line interface tool for solution composition and decomposition, in accordance with aspects of the disclosure.

FIGS. 2A-2C illustrate example component data that is used during solution composition and decomposition, in accordance with aspects of the disclosure.

FIGS. 3A-3B illustrate an example of auto-connecting components during solution composition and decomposition, in accordance with aspects of the disclosure.

FIG. 4 illustrates example command line interface commands for solution composition and decomposition, in accordance with aspects of the disclosure.

FIGS. 5A-5C illustrate an example of defining input and output variables during solution composition and decomposition, in accordance with aspects of the disclosure.

FIG. 6 illustrates a flow diagram for an example method for performing solution composition and decomposition, in accordance with aspects of the disclosure.

FIG. 7 illustrates a block diagram of an example computing environment for performing solution composition and decomposition, in accordance with aspects of the disclosure.

### DETAILED DESCRIPTION

### Overview

The present disclosure provides a command line interface (CLI) tool that is configured to analyze a software solution structure, decompose the software solution structure into individual components, and modify or manipulate the individual components to generate a solution. The CLI tool may also be configured to generate a solution from scratch based on repetitive composition application.

Given a software solution, the CLI tool may be configured to perform one or more solution composition operations. For example, the CLI tool may (1) describe the composition of the solution at varying levels of granularity, (2) extract components of the solution (also referred to herein as a composite) based on identifiers that are associated with the components and add copies of the extracted components to different solutions as fragments, (3) add fragments into a solution and issue warnings when manual adjustments are needed, (4) evaluate whether a component can fit into a solution, and (5) evaluate when components are mutually exclusive and issue alerts when more than one mutually exclusive component is used within a solution.

The CLI tool may define units of composition, also referred herein as components. At least two components may be connected together to form a novel software solution. In some instances, a component may be represented as a terraform module. A terraform module is a directory with one or more files that store data that describes the component, as discussed in detail below. One of the files may be a main.tf file, which may contain one or more logically related terraform resources. The terraform resources may be grouped together to form a terraform module (also referred to herein as a component or a unit of composition).

As introduced above, the components may be terraform modules. Terraform modules are described herein by way of example as additional or alternative collections of configuration files may be used.

The terraform modules may group together logically related terraform resources to form a single component. In some instances, the single component may represent a cloud component, an infrastructure component, or the like. The terraform modules may have input variables, output variables, and a configuration file containing information about additional components to which the module may be connected. The connection between two or more modules may be made using each component's input and output variables. When components are connected, values of the output variables of one component may be the values of the input variables of a different component. The connections between components may be applied automatically by the CLI tool. The CLI tool may perform auto-connection of two or more components based on different circumstances. For example, components may undergo auto-connection when the components are logically related, when the logically related components are both included in the solution, or the like. The CLI tool may determine whether to auto-connect components based on data that describes inter-component relationships and is stored in one or more files associated with component. For example, such data may be stored in a metadata.yaml file, as discussed in detail below. The inter-component relationship data may identify pairs of components to be auto-connected such that if a first component of the pair is already in the solution and a second component of the pair is added to the solution, then the CLI tool auto-connects the first and second components.

The CLI tool may be configured to read a terraform and decompose the terraform into a graph-like structure where the components are represented via nodes and the connections between components are represented via edges. New components may be added to the graph and new connections may be created. The graph may be used to generate the final terraform.

The units of composition may be represented in a directory for each terraform module and may contain one or more files. For example, a directory may include files that contain one or more logically related terraform resources which, when combined, represent one component (referred to herein as main.tf), files that contain terraform provider information for the resources used in main.tf (referred to herein as versions.tf), files that contain input variables used by the terraform module (referred to herein as variables.tf), files that contain output variables used by the terraform module (referred to herein as output.tf), and files that contain additional information about the input variables and inter-component relationships (referred to herein as metadata.yaml).

One or more directories may be made available to users of the CLI tool to generate software solutions. To generate a solution, a user may create an empty directory, where the empty directory may represent an empty solution. Users may use the CLI tool within the empty directory to perform one or more operations. For example, users may use the CLI tool to add an instance of a component from a catalog to the empty solution. When the component is added to the empty solution, the CLI tool may populate the directory with copies of the modules that are used in the solution. In some instances, main.tf may contain the terraform for the solution. Further, in some instances, variables.tf may contain the input variables for the solution for which values are needed from the user. In some instances, outputs.tf may contain the output variables for the solution.

Users may connect (or compose) two or more components of the solution. For example, the values of one or more output variables of a first component may be the values of one or more input variables of a second component. The components that are connected in this way may be identified in the metadata.yaml files associated with the components. In particular, the metadata.yaml files associated with the components may define the connection information, where the connection information identifies which output variable of the first component is fed into which input variable of the second component. Users may interact with such components by adding them to the solution and manually inter-connecting the components in the solution and/or manually removing the auto-connection.

In some instances, the value of an input variable might not be derived from an output variable of another component. Instead, some input variables may be referred to as user-defined input variables and may be added to variables.tf to be defined by the user. Two types of input variables are described herein-global and non-global. A global input variable may have the same value across all components within the solution. The information within metadata.yaml may identify the global input variables using, for example, isGlobal: true. A non-global variable may have specific values for each component of the solution. The information within metadata.yaml may identify the non-global input variables using, for example, isGlobal: false. Each instance of a non-global variable may include a prefix appended to the name of the component. As such, each instance of the non-global variable may be associated with a unique name and value.

In some instances, the value of an output variable in one component might not be used as the value of an input variable in a different component. Instead, the output variable may be added to outputs.tf to be defined by the user.

Some components may be auto-connected with at least one other component. In some instances, the connection may be based on manual intervention from the user. However, in some instances, auto-connection may occur without manual intervention from the user. When auto-connection occurs without intervention from the user, the user may manually remove the connection. The information within metadata.yaml may indicate the components that may be auto-connected to other components.

The CLI tool may support one or more commands that the user may execute to add components to the solution. For example, the one or more commands may include: listComponents which, when executed, generates a list of supported components for composition; addComponent which, when executed, adds a new component to the solution; removeComponent which, when executed, removes a component from the solution; connectComponents which, when executed, connects two existing components of a solution; disconnectComponents which, when executed, disconnects two existing connected components of a solution; recommendConnections which, when executed, identifies possible connection between the given component in the command and the components present in the solution; describe which, when executed, prints the components and their connections in the provided solution.

The user may access one or more repositories to call one or more units of composition. Using the CLI tool, the user may add units of composition to a solution. Further, using the CLI tool, the user may execute one or more CLI commands to modify the components added to the empty solution. In some instances, the CLI tool may include a knowledge layer. The knowledge layer may include auto-connection information that may be read from metadata.yaml. For example, the auto-connection information may indicate the components that may be connected to other components. The knowledge layer may also include component-specific information. For example, the component-specific information may indicate a component's input variable, output variables, and/or variable values that may be read from the component's terraform files and/or metadata.yaml. Further, the knowledge layer may include information on inter-component relationships, which may be read from metadata.yaml of the components.

The CLI tool described herein is advantageous in a number of respects. It provides an approach to software solution composition that includes calling defined components from a library and connecting two or more components. The CLI tool offers connection suggestions based on existing components within a solution. The CLI tool further offers auto-connection that identifies two or more components that are likely to be combined and connects the components. The supported CLI commands provide simplified methods of adding, removing, replacing, or swapping components. This allows users to easily add complimentary services to the generated solutions. The CLI tool may be used for software solution generation within a variety of industries and the public sector.

### Example Systems

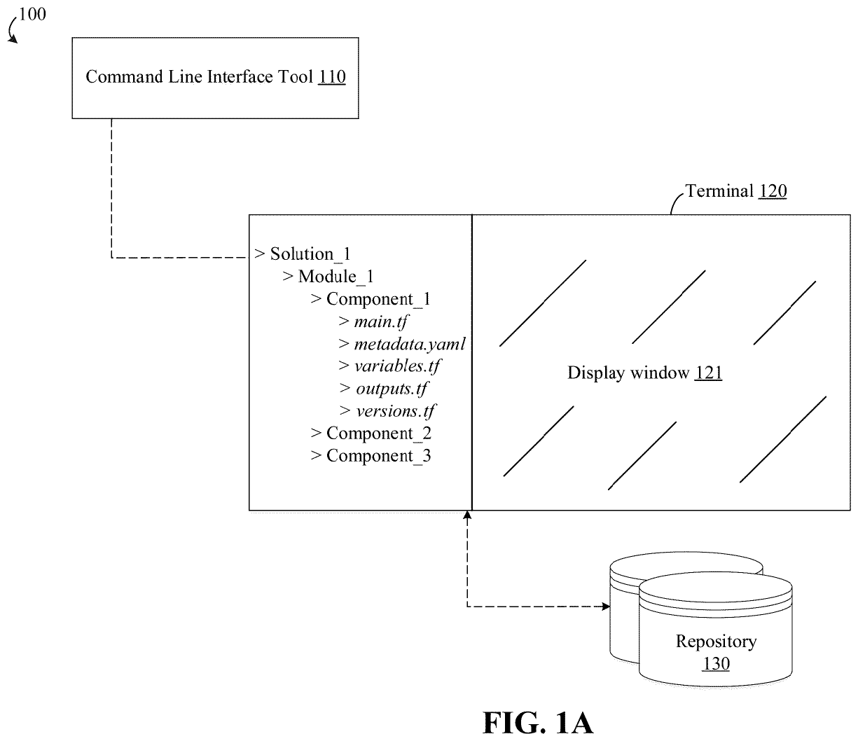

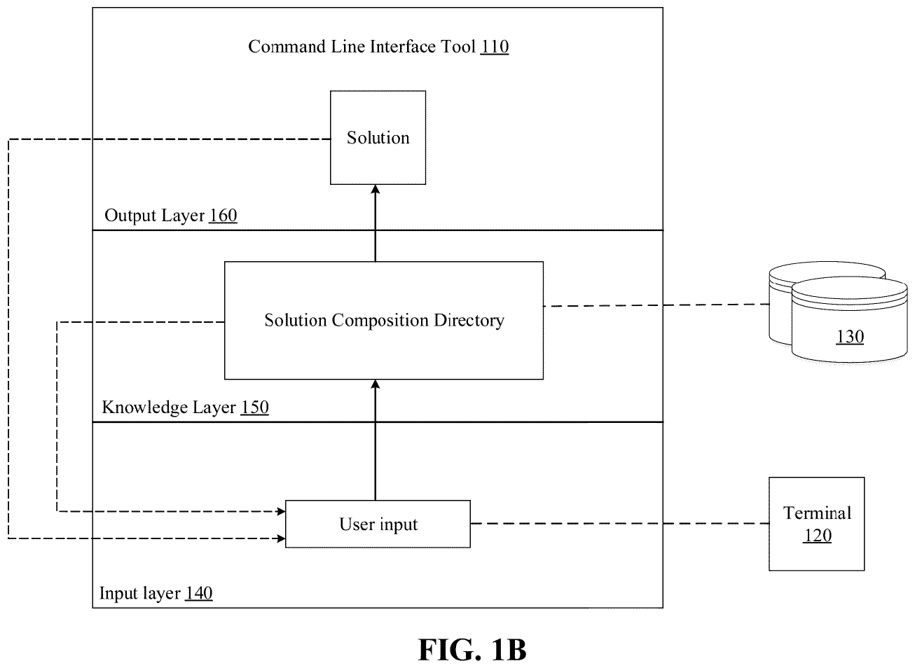

FIG. 1A illustrates an example computing environment for performing solution composition and decomposition. Computing environment 100 may include command line interface (CLI) tool 110, terminal 120, and repository 130. CLI tool 110 may exist within a computing device and may be used to generate software solutions (referred to herein as solutions). For example, CLI tool 110 may be used to design application architecture that is configured to execute a solution. CLI tool 110 may receive input from a user associated with the computing device. The user input may include user commands to add, remove, and/or modify one or components within the solution.

Each component may include a feature of the solution. A feature may identify an environment within which the solution may be deployed, a method of collecting input data, at least one method of analyzing the input data, a method of producing an output, or the like. Components may be selected from a list of components that are supported by CLI tool 110, referred to herein as a plurality of supported components. However, in some instances, components may be user-defined components that may be manually added to the solution via user input.

The plurality of supported components may be stored in repository 130 and may be displayed to the user. For example, the plurality of supported components may be presented to the user for selection via terminal 120. Terminal 120 may be a working directory that displays the backend development of the solution for user interaction and modification. As illustrated in FIG. 1, terminal 120 may list the contents of the solution. In particular, terminal 120 may list modules that are called during the execution of the solution. Each module may contain one or more components that are supported by the module and, by extension, supported by CLI tool 110. While a single solution and a single module are illustrated in FIG. 1, terminal 120 may list more than one solution and module. The single solution and module are depicted for illustration purposes only.

Each component may contain one or more files that store component-specific data. For example, a given component may contain a file that identifies other components that are logically related to the given component, a file that identifies at least one provider of the given component and/or the other components that are logically related to the given component, a file that identifies input variables of the given component, a file that identifies output variables of the given component, or a file that includes metadata associated with the given component. The files depicted in FIG. 1 correspond to terraform modules for illustration purposes only as other file configuration methods may be used herein. The named files depicted in FIG. 1 are for illustration purposes only as the files associated with a component may have different names and may derive from different file configuration methods. Furthermore, while five files are depicted within Component_1 of FIG. 1, a component may have more or fewer than five files.

Components may be selected within terminal 120 using any appropriate mechanism or technique for generating user input, such as a keyboard, mouse, mechanical actuators, soft actuators, touchscreens, microphones, sensors, or the like. A selected component may be displayed via a display associated with the terminal. For example, the selected component may be displayed via display window 121 of terminal 120. In some instances, displaying the selected component may include displaying one or more files associated with the selected component. The display of the selected component may prompt the user to select a file for display.

The display of the selected component and the one or more files associated with the selected component may feature source code that is used to build the selected component. The source code may contain notes that explain the functionality of different parts of the component, the functionality of different variable values, or the like. Further, in some instances the notes may identify different components that may be logically related to the selected component.

The data that is displayed within display window 121 may originate from repository 130. Repository 130 may include one or more directories, where each directory may contain component data at increasing levels of granularity. For example, a directory may store the plurality of supported components while at least one other directory may identify, for each module, components associated with the module. Furthermore, repository 130 may store, for each component, a directory containing component-specific data, such as the one or more files associated with a component. The directories stored within repository 130 may be displayed via terminal 120. In some instances, the directories may be displayed within an interactive menu, where each sub-menu may describe a solution at increasing levels of granularity. The interactive menu may receive user selection of an item to be displayed.

Repository 130 may further store component-specific data that might not be displayed, for example, via terminal 120. Repository 130 may maintain historical directories. The historical directories may store previously composed solutions, previously decomposed solutions, component connection recommendations based on the previously composed and decomposed solutions, solution-specific required component connections, graph-like structures representing the decomposition of previously composed solutions, or the like. In some instances, this data may be stored in a single historical directory. However, in some instances, each category of historical data may be stored in distinct directories. In instances where distinct directories are used, one or more directories may be linked to illustrate relationships between the components.

FIG. 1B illustrates an example command line interface tool for solution composition and decomposition. CLI tool 110 may include input layer 140, knowledge layer 150, and output layer 160. Knowledge layer 150 may include a solution composition directory, which may be a command line environment within which CLI tool 110 may generate the solution based on user commands. As described above, CLI tool 110 may interact with at least one user associated with the host computing device. In particular, CLI tool 110 may receive user input via input layer 140. The user input may correspond to user commands. For example, user commands may include a command to generate an empty solution composition directory for generating a new solution, a command to add components to the solution, one or more commands to modify the solution and/or the components therein, or the like. CLI tool 110 may receive the user input via any appropriate mechanism or technique for generating user input, such as a keyboard, mouse, mechanical actuators, soft actuators, touchscreens, microphones, sensors, or the like.

As previously introduced, CLI tool 110 may create the empty solution composition directory based on receiving a user command to do so. The solution composition directory may be a command line computing environment within which CLI tool 110 generates the source code corresponding to the solution. To generate the solution, CLI tool 110 may receive user input indicating at least one component to be added to the solution. Components may be the building blocks of the solution. A component may correspond to commands to be performed during execution of the solution. Two or more components may be connected (or composed) together to create at least a portion of the solution.

Each component may be associated with a terraform module that may represent, for example, a cloud platform component or a cloud infrastructure component. Terraform modules are described herein by way of example only as additional or alternative collections of configuration files may be used. In some instances, a component may be a group of terraform resources.

In some instances, components may be selected for addition to the solution based on interactions between CLI tool 110 and terminal 120. In particular, users associated with input layer 140 may access the resources and data available via terminal 120 to select one or more components to be added to the solution. Terminal 120 may display a plurality of modules and components that are supported by CLI tool 110. At least some of the data associated with each supported module and each supported component may describe the functionality of each module and component. Such data may be used, by the user for example, to determine the components to be added to the solution.

Terminal 120 may receive user input on the interactive menu listing the supported modules and supported components. Based on the received user input indicating user selection of a supported module or supported component, a directory that corresponds to the user selection may be displayed via terminal 120. The data that is displayed may be used to determine whether to add the user selection to the solution, remove the user selection from the solution, modify the solution based on the data displayed, or the like. For example, CLI tool 110 may receive, based on the user interaction with terminal 120, user commands for populating the empty solution composition directory.

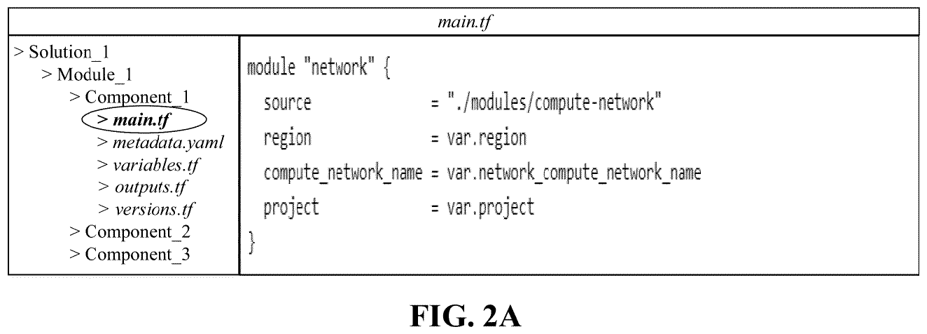

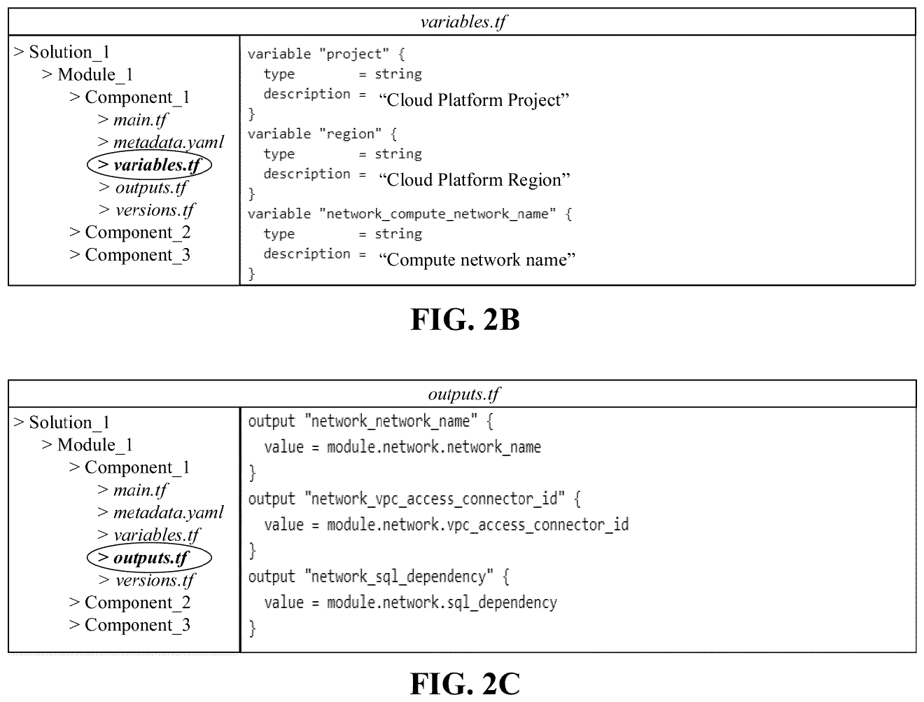

FIGS. 2A-2C illustrate example component data that is used during solution composition and decomposition. In particular, each of FIGS. 2A-2C illustrate an example representation of terminal 120. A part of the example representation of terminal 120 includes the described interactive menu of supported modules and supported components. A different part of the example representation of terminal 120 includes a populated display window. As illustrated in FIG. 2A, a directory that corresponds to a file of Component_1 is displayed via the example representation of terminal 120. In particular, the directory displayed via the example representation of terminal 120 corresponds to a main.tf file, which is bolded and encircled to indicate user selection of the file. The data within main.tf may be used to identify the component to which the file corresponds and the module that supports the component. For example, FIG. 2A indicates that the user-selected main.tf file corresponds to a compute-network component which is supported by a network module. Further, the data within main.tf indicates that there are at least four variables associated with the compute-network component, namely source, region, compute_network_name, and project.

The displayed main.tf file includes a terraform that may be used to generate the solution. While FIG. 2A illustrates the user selection of a file associated with a component that is supported by CLI tool 110, additional or alternative implementations may feature user selection of a component and/or a module that supports that component. User selection of a component file is illustrated in FIG. 2A for illustration purposes only, not limitation. Further, user selection of the main.tf file of the component is illustrated in FIG. 2A for illustration purposes only as alternative component files may be selected for display.

For example, as illustrated in FIG. 2B, a different directory that corresponds to Component_1 may be displayed via the example representation of terminal 120. In particular, the directory displayed corresponds to a variables.tf file, which is bolded and encircled to indicate user selection of the file. The variables.tf file may contain data that indicates input variables of the corresponding component as well as characteristics of the input variables. For example, the displayed data may indicate, at least, that the input variables of the compute-network component are each a string type and each contain an input variable description.

Further still, as illustrated in FIG. 2C, a different directory that corresponds to Component_1 may be displayed via the example representation of terminal 120. In particular, the directory displayed corresponds to an outputs.tf file, which is bolded and encircled to indicate user selection of the file. The outputs.tf file may contain data that indicates output variables of the corresponding component as well as values of the output variables.

Returning to the discussion of FIG. 1B, in some instances, the user input generated in input layer 140 may be based on user interactions with the component data displayed via terminal 120. However, in some instances, CLI tool 110 may receive user commands to populate the empty solution composition directory with user-defined components. The user-defined components may be created, for example, via terminal 120 based on user input. In particular, user input may trigger the creation of a new directory and may include user-generated source code that is needed for the execution of the solution of which the user-defined component is a part. The new directory created via terminal 120 may be stored within repository 130 based on further user input.

One or more components may be selected or defined in input layer 140 and may be fed into knowledge layer 150 as input. More specifically, the components may be used to populate the empty solution composition directory, which, when populated, is referred to herein as the solution composition directory. Within knowledge layer 150, CLI tool 110 may perform one or more operations on the components added to the solution composition directory. For example, CLI tool 100 may perform one or more automatic connections (referred to herein as auto-connections) of the components added to the solution composition directory.

To do so, CLI tool 110 may access, for each component added to the solution composition directory, a corresponding metadata.yaml file that is stored in repository 130. Each metadata.yaml file may identify other components, if any, to which a component should be connected. Based on determining that a component within the solution composition directory is flagged for auto-connection with at least one other component. CLI tool 110 may determine whether the at least one other component is in the solution composition directory. Based on determining that the at least one other component is in the solution composition directory, CLI tool 110 may perform the auto-connection of the component and the at least one other component.

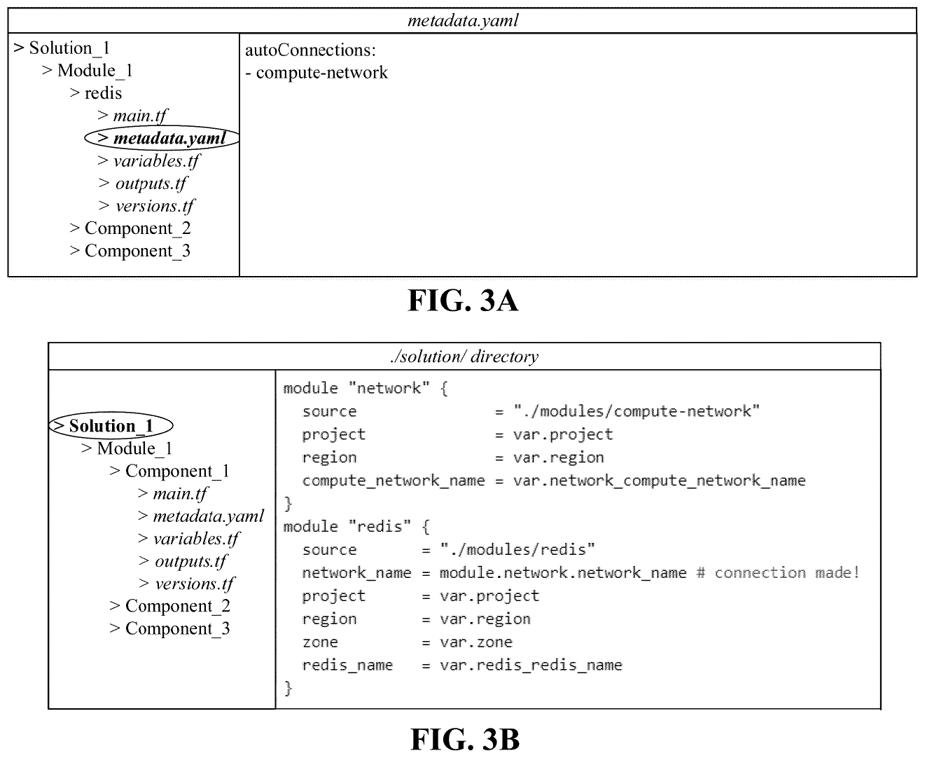

FIGS. 3A-3B illustrate an example of performing automatic component connection during solution composition and decomposition. The compute-network and redis components are auto-connected in FIGS. 3A-3B for illustration purposes only and not limitation as different combinations of components may be auto-connected. FIG. 3A illustrates an example metadata.yaml file that corresponds to the redis component. As illustrated in FIG. 3A, the metadata.yaml file indicates that the redis component is auto-connected to the compute-network component. More specifically, the metadata.yaml file indicates that the redis component is auto-connected to the compute-network component when both components are added to the solution composition directory. FIG. 3B illustrates an example directory containing module and component data of the solution generated by CLI tool 110. As illustrated in FIG. 3B, the solution includes both the compute-network and redis components. As such, the components are auto-connected. More specifically, an output value of the network_name variable of the redis component is based on an input value of the compute_network_name variable of the compute-network component.

Returning to the discussion of FIG. 1B, in some instances, CLI tool 110 may determine whether to perform auto-connection of two or more components based on analyzing the data stored in the directories within repository 130 to identify inter-component relationships. An inter-component relationship may include two or more components that are linked via the variable values therein. For example, when an output variable value of a first component is used as an input variable value of a second component, the first and second components have an inter-component relationship. In some instances, inter-component relationships may refer to component relationships generally. For example, components that are logically related may be in an inter-component relationship. Components that are logically related might not be linked via the variable values therein.

CLI tool 110 may access the historical directories within repository 130. In particular, CLI tool 110 may parse the directories containing previously composed solutions, previously decomposed solutions, solution-specific required component connections, or the like. CLI tool 110 may determine whether a component added to the solution composition directory was used in at least one previously composed or decomposed solution.

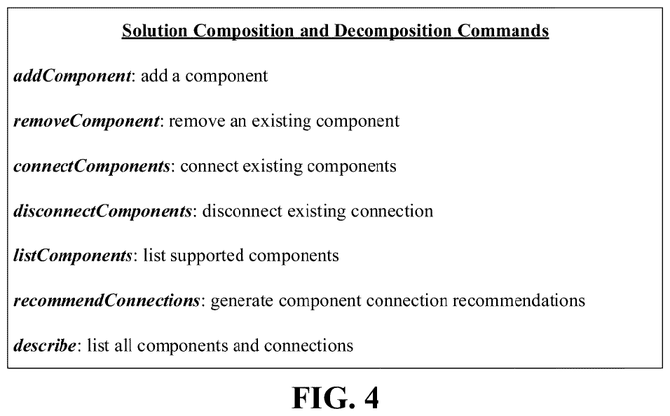

CLI tool 110 may display the automatic component connections described above in the solution composition directory within knowledge layer 150. The contents of the solution composition directory may be fed into input layer 140 for user review. CLI tool 110 may receive, via user input, one or more commands to modify the current state of the solution in the solution composition directory. FIG. 4 illustrates example command line interface commands for solution composition and decomposition. CLI tool 110 may receive user commands to disconnect components that were automatically connected (disconnectComponents), manually connect two or more components (connectComponents), add additional components (addComponent), remove components (removeComponent), or the like.

Furthermore, CLI tool 110 may receive one or more user commands to describe the current state of the solution, generate recommendations, or the like. For example, CLI tool 100 may receive user commands to list all components within the current state of the solution (listComponents), recommend component connections between the components within the current state of the solution (recommendConnections), list all components within the solution and all connections between the components (describe), or the like. The one or more user commands may be generated within input layer 140 and may be fed to knowledge layer 150 to further modify the solution.

The components within the solution composition directory may be further modified based on user input via input layer 140. For example, CLI tool 110 may receive user input directed toward defining input variable values and output variable values. In some instances, the value of an input variable of a first component may depend on the value of an output variable of a second component. However, in some instances, the values of input and output variables may be independent of other variable values. In some instances, the value of an input variable might not be derived from an output variable of another component. Instead, some input variables may be referred to as user-defined input variables and may be defined by the user in the variables.tf directory of the corresponding component. Similarly, output variables may be referred to as user-defined output variables and may be defined by the user in the outputs.tf directory of the corresponding component.

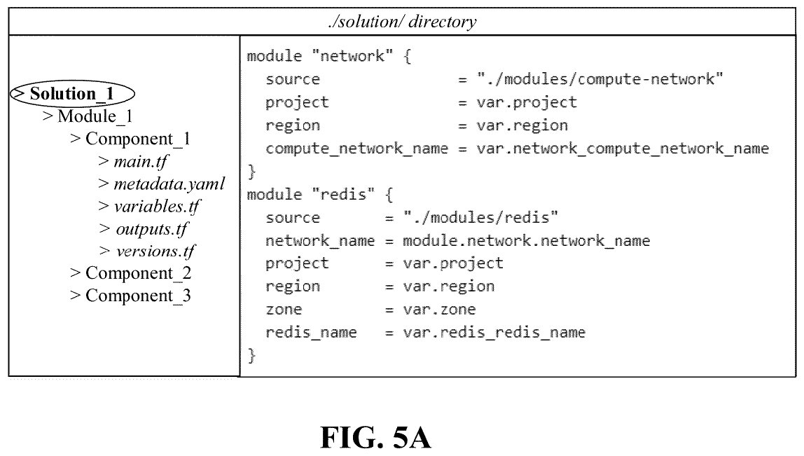

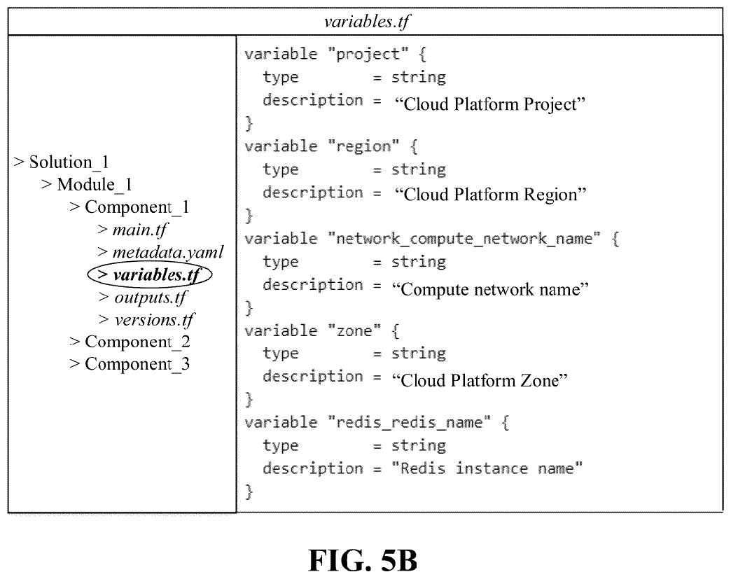

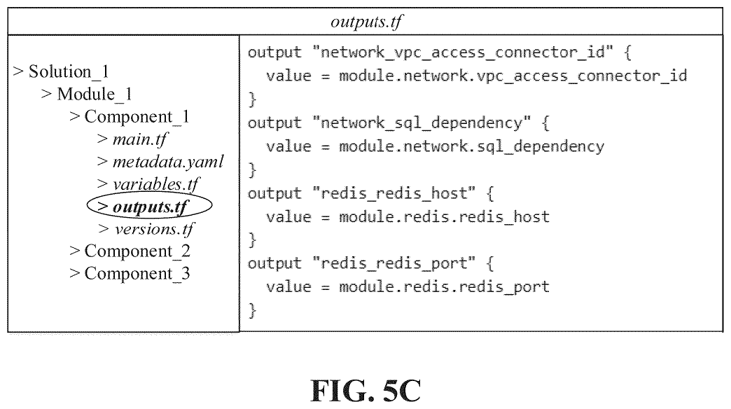

FIGS. 5A-5C illustrate an example of defining input and output variables during solution composition and decomposition. FIG. 5A illustrates an example directory containing module and component data of the solution generated by CLI tool 110. As illustrated in FIG. 5A, the solution includes both the compute-network and redis components. The variables associated with the compute-network component include project, region, and compute_network_name. The variables associated with the redis component include network_name, project, region, zone, and redis_name. While FIG. 5A illustrates particular variables associated with two components, more or fewer than two components may exist within the solution and more or fewer variables may be associated with each component. The variables indicated in FIG. 5A are defined in the examples illustrated in FIGS. 5B-5C.

FIG. 5B illustrates an example directory containing input variables associated with the components within the solution. In particular, FIG. 5B illustrates, for each component included in the solution, input variables and corresponding values. An input variable may be defined using, at least, an input variable value type and a description of the input variable. Two types of input variables are described herein-global and non-global. A global input variable may have the same value across all components within the solution. The information within metadata.yaml may identify the global input variables using, for example, isGlobal: true. A non-global variable may have specific values for each use in different components of the solution. The information within metadata.yaml may identify the non-global input variables using, for example, isGlobal: false. Each instance of a non-global variable may include a prefix appended to the name of the component. As such, each instance of the non-global variable may be associated with a unique name and value.

FIG. 5C illustrates an example directory containing output variables associated with the components within the solution. In particular, FIG. 5C illustrates, for each component included in the solution, output variables and corresponding values. The variable values indicated in FIGS. 5B-5C may be defined and/or modified based on accessing the variables.tf and outputs.tf directories of the corresponding component via user input within terminal 120. The updated and/or modified directories may be stored within repository 130. Furthermore, the updated and/or modified directories may be used to update the solution within the solution composition directory.

Returning to the discussion of FIG. 1B, the components that are added to the solution composition directory via user input may also be modified via user input. For example, the variables within the components may be defined based on user input, components may be connected based on user input, or the like. Each modification to the solution may be fed back into input layer 140 for continuous user review. A final solution may be a final terraform indicating each component and corresponding module that is called during execution of the solution. The final solution may flow from knowledge layer 150 to output layer 160 based on one or more user commands to execute the solution. In some instances, a user command that signals the creation of the final solution may be a user command to compile the final solution, a user command to run the final solution, a user command to initialize an application to host the final solution, or the like.

In some instances, the creation of the final solution may also include solution decomposition. Solution decomposition may include decomposing the final terraform in a graph-like structure. The nodes on the structure may represent the components of the final terraform while the edges may represent component connections. The structure may be modified as additional components are added to the final solution, removed from the final solution, new connections are added to the solution, existing connections are removed from the final solution, or the like. The structure may be updated to generate an updated terraform. The final terraform (or final solution) and the structure may be stored in the historical directories of repository 130. The final terraforms and structures that are store within repository 130 may be analyzed during the creation of subsequent solutions.

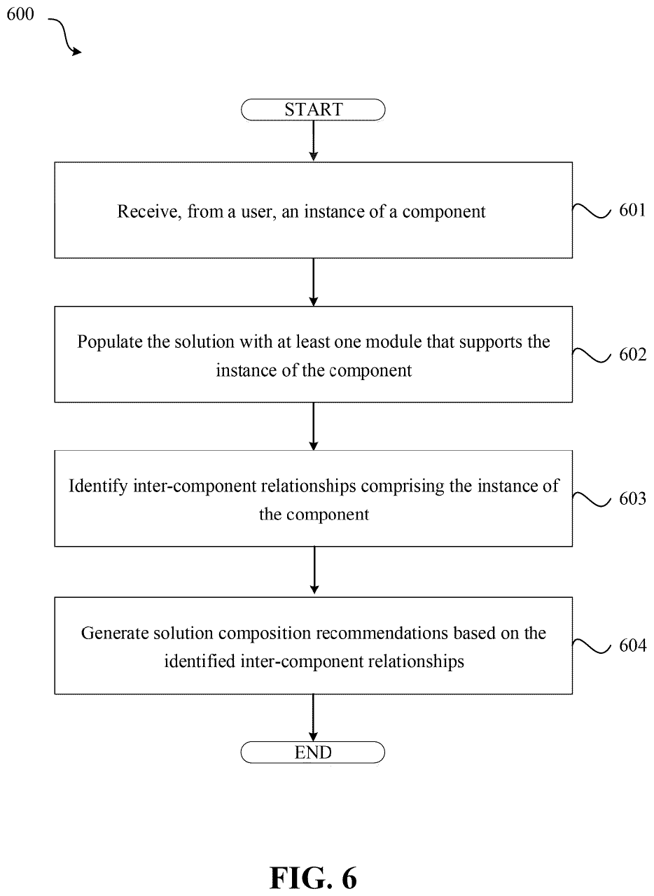

FIG. 6 illustrates a flow diagram for an example method for performing solution composition and decomposition. The operations described herein are presented in the current order by way of example, and the order is not meant to be limiting. Moreover, operations may be omitted from or added to the example method.

At block 601, a command line interface tool may receive, from a user, an instance of a component. CLI tool 110 may receive user input via input layer 140. The user input may include a user command to add the instance of the component to a software solution. CLI tool 110 may generate the software solution within a solution composition directory therein. Therefore, CLI tool 110 may add the user selected component to the solution composition directory to be called during execution of the solution.

At block 602, the command line interface tool may populate the solution with at least one module that supports the instance of the component. CLI tool 110 may access one or more directories within repository 130, which may store component-specific directories. The component-specific directories may store data that describes each component as well as the modules associated with the component. CLI tool 110 may identify the module associated with the user elected component and may add the module to the directory files that support the backend development of the solution. Doing so may trigger the inclusion of the module within the solution.

At block 603, the command line interface tool may identify inter-component relationships that include the instance of the component. CLI tool 110 may parse the one or more solution composition files associated with the component. In particular, CLI 100 may parse a metadata.yaml file that is associated with the component. CLI 110 may determine, based on the parsing, whether a different component (referred to in this example as a second component) is logically related to the component. The component and the second component may be logically related when the component and the second component have linked variable values. Based on determining that the component and the second component have linked variable values, CLI 110 may determine that the component and the second component have an inter-component relationship.

At block 604, the command line interface tool may generate solution composition recommendations based on the identified inter-component relationships. In some instances, CLI tool 110 might not automatically connect the components that are determined to have an inter-component relationship. In such instances, CLI tool 110 may generate recommendations to connect the components that have an inter-component relationship. The inter-component relationship may indicate that the components have linked variable values. CLI tool 110 may generate a recommendation to connect components based on parsing one or more solution composition metadata files, such as the metadata.yaml file. CLI tool 110 may identify, with the metadata.yaml file, a second component that has an inter-component relationship with the component. CLI tool 110 may determine whether the second component is included in the solution and, based on determining that the second component is included in the solution, may generate a suggestion to the connect the first component and the second component.

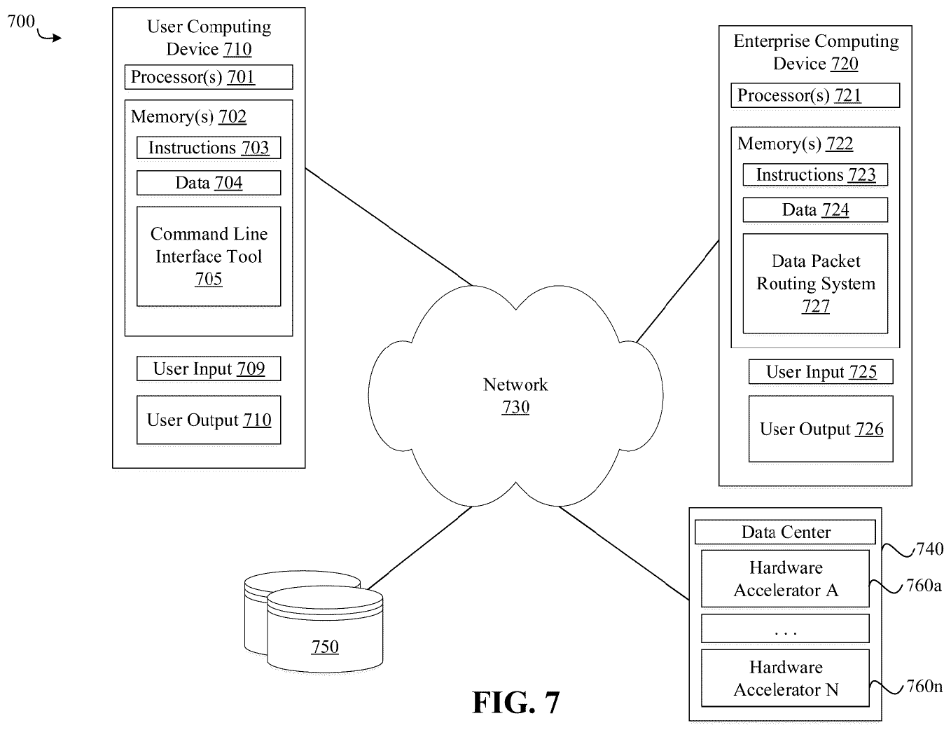

FIG. 7 illustrates a block diagram of an example computing environment for performing solution composition and decomposition. Solution composition and decomposition may be performed by one or more computing devices. For example, a user computing device 710 and enterprise computing device 720 may be configured to perform solution composition and decomposition. User computing device 710 and enterprise computing device 720 may be communicatively coupled to one or more storage devices over a network. The storage devices may be a combination of volatile and non-volatile memory and may be at the same or different physical locations than the computing devices. For example, the storage devices may include any type of non-transitory computer readable medium capable of storing information, such as a hard-drive, solid state drive, tape drive, optical storage, memory card, ROM, RAM, DVD, CD-ROM, write-capable, and read-only memories.

User computing device 710 may include one or more processors and memory, such as processor(s) 701 and memory(s) 702 (referred to herein as memory 702). Memory(s) 702 may include instructions 703, data 704, and command line interface tool 705. Computing device 710 may also include a user input and a user output, such as user input 709 and user output 710.

Memory 702 may store information accessible by the processors, including instructions that may be executed by the processors. Memory 702 may also include data that may be read, retrieved, manipulated, or stored by the processors. Memory 702 may be a type of non-transitory computer readable medium capable of storing information accessible by the processors, such as volatile and non-volatile memory. The processors may include one or more central processing units (CPUs), graphic processing units (GPUs), field-programmable gate arrays (FPGAs), and/or application-specific integrated circuits (ASICs), such as tensor processing units (TPUs).

Instructions 703 may include one or more instructions that, when executed by the processors, cause the one or more processors to perform actions defined by the instructions. Instructions 703 may be stored in object code format for direct processing by the processors, or in other formats including interpretable scripts or collections of independent source code modules that are interpreted on demand or compiled in advance. Instructions 703 may include instructions for performing solution composition and decomposition.

Data 704 may be read, retrieved, stored, or modified by the processors in accordance with the instructions. Data 704 may be stored in computer registers, in a relational or non-relational database as a table having a plurality of different fields and records, or as JSON, YAML, proto, or XML documents. Data 704 may also be formatted in a computer-readable format such as, but not limited to, binary values, ASCII, or Unicode. Moreover, data 704 may include information sufficient to identify relevant information, such as numbers, descriptive text, proprietary codes, pointers, references to data stored in other memories, including other network locations, or information that is used by a function to calculate relevant data.

Command line interface tool 705 may be configured to receive user input and/or user commands to generate a solution including one or more components. Command line interface tool 705 may analyze previously composed solutions to determine whether to perform automatic component connection between the user selected components that are added to the solution. In some instances, command line interface tool 705 may be configured to generate component connection recommendations based on the analysis of the previously composed solutions.

User input 709 may include any appropriate mechanism or technique for receiving input, such as keyboard, mouse, mechanical actuators, soft actuators, touchscreens, microphones, and sensors. In some implementations, user input 709 may be used to receive notifications indicating updates and or modifications to the solution.

User output 710 may be used to display the one or more updates and or modifications to the solution. In some instances, user output 710 may be used to display one or more components or modules added to the solution.

Enterprise computing device 720 may also be configured similarly to user computing device 710, with one or more processors, memory, instructions, and data, such as processor(s) 721, memory(s) 722, instructions 723, data 724, and command line interface tool 727. Enterprise computing device 720 may also include a user input and a user output, such as user input 725 and user output 726. User input 725 may include any appropriate mechanism or technique for performing solution composition and decomposition, such as keyboard, mouse, mechanical actuators, soft actuators, touchscreens, microphones, and sensors. User output 726 may be used to display the one or more updates or modifications to the solution. User output 726 can alternatively or additionally include one or more speakers, transducers or other audio outputs, a haptic interface or other tactile feedback that provides non-visual and non-audible information to the platform user of the enterprise computing device 720.

Although FIG. 7 illustrates the processors and the memories as being within the computing devices, components described herein can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operation. The computing devices can each include one or more internal clocks providing timing information, which can be used for time measurement for operations and programs run by the computing devices.

User computing device 710 may be connected over network 730 to a data center housing any number of hardware accelerators, such as data center 740 housing hardware accelerators 760a-1160n. Data center 740 can be one of multiple data centers or other facilities in which various types of computing devices, such as hardware accelerators, are located. Computing resources housed in the data center can be specified for performing solution composition and decomposition, as described herein.

The solutions generated by the command line interface tools may be stored in database 750. In some instances, database 750 may store historical databases that include one or more directories containing previously composed solutions.

User computing device 710, enterprise computing device 720, and data center 740 may be capable of direct and indirect communication over network 730. For example, using a network socket, enterprise computing device 720 may connect to a service operating in data center 740 through an Internet protocol. User computing device 710 and enterprise computing device 720 may set up listening sockets that may accept an initiating connection for sending and receiving information. Network 730 itself may include various configurations and protocols including the Internet, World Wide Web, intranets, virtual private networks, wide area networks, local networks, and private networks using communication protocols proprietary to one or more companies. Network 730 may support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. Network 730 may, in addition or alternatively, also support wired connections between the devices and the data center, including over various types of Ethernet connection.

It is understood that the aspects of the disclosure may be implemented according to a variety of different configurations and quantities of computing devices, including in paradigms for sequential or parallel processing, or over a distributed network of multiple devices.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers or special purpose logic circuitry, such as a system on chip (SoC) executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks. DVD-ROM disks, or combinations thereof.

Aspects of the disclosure can be implemented in a computing system that includes a back-end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A command line interface tool for generating a solution comprising one or more components, the command line interface tool comprising one or more processors configured to:
receive, from a user, an instance of a component;
populate the solution with at least one module that supports the instance of the component;
identify inter-component relationships comprising the instance of the component; and
generate solution composition recommendations based on the identified inter-component relationships.

2. The command line interface tool of claim 1, wherein the component comprises one or more solution composition files, wherein the one or more solution composition files comprise:
a directory of one or more logically related resources used in the solution;
a directory storing data that identifies providers of the one or more logically related resources;
a directory of input variables to be defined in the solution;
a directory of output variables to be defined in the solution; and
a directory of data that corresponds to the inter-component relationships.

3. The command line interface tool of claim 2, wherein defining the input variables and the output variables comprises receiving a user command identifying global variables, wherein a global variable has a same user-defined value across all components within the solution.

4. The command line interface tool of claim 2, wherein defining the input variables and the output variables comprises receiving a user command identifying non-global variables, wherein a non-global variable has a unique user-defined value in each component within the solution.

5. The command line interface tool of claim 2, wherein defining the input variables and the output variables is based on metadata within the one or more solution composition files, the metadata identifying values of the output variables of the component that are used as values of input variables of a second component.

6. The command line interface tool of claim 2, wherein identifying the inter-component relationships further causes the one or more processors to:
parse the one or more solution composition files comprising metadata associated with the component; and
determine, based on the parsing, whether a second component is logically related to the component, the second component being logically related when the component and the second component have linked variable values.

7. The command line interface tool of claim 1, wherein the one or more processors are configured to parse one or more directories comprising definitions of the component and the at least one module, wherein the definitions comprise one or more commands supported by the component.

8. The command line interface tool of claim 1, wherein the one or more processors are configured to generate a graph that represents connections between two or more components, the graph comprising:
nodes that represent the components; and
edges that represent connections between the components.

9. The command line interface tool of claim 1, wherein the one or more processors are configured to:
receive, from the user, a command to remove an auto-connection between two or more components; and
modify the solution based on the received user command.

10. The command line interface tool of claim 1, wherein generating solution composition recommendations further causes the one or more processors to:
parse one or more solution composition files comprising metadata associated with the component;
identify a second component within the solution that is logically related to the component; and
recommend that the component and the second component within the solution be connected.

11. A method for performing solution composition, the method comprising:
receiving, by a command line interface tool and from a user, an instance of a component;
populating, by the command line interface tool, a solution with at least one module that supports the instance of the component;
identifying, by the command line interface tool, inter-component relationships comprising the instance of the component; and
generating, by the command line interface tool, solution composition recommendations based on the identified inter-component relationships.

12. The method of claim 11, wherein identifying the inter-component relationships comprises:
parsing, by the command line interface tool, one or more solution composition files comprising metadata associated with the component; and
determining, by the command line interface tool and based on the parsing, whether a second component is logically related to the component, the second component being logically related when the component and the second component have linked variable values.

13. The method of claim 11, further comprising parsing, by the command line interface tool, one or more directories comprising definitions of the component and the at least one module, wherein the definitions comprise one or more commands supported by the component.

14. The method of claim 11, further comprising generating a graph that represents connections between two or more components, the graph comprising:
nodes that represent the components; and
edges that represent connections between the components.

15. The method of claim 11, further comprising:
receiving, by the command line interface tool and from the user, a command to remove an auto-connection between two or more components; and
modifying the solution based on the received user command.

16. A non-transitory computer readable storage medium storing instructions that, when executed by one or more processors for performing solution composition, cause the one or more processors to:
receive, from a user, an instance of a component;
populate a solution with at least one module that supports the instance of the component;
identify inter-component relationships comprising the instance of the component; and
generate solution composition recommendations based on the identified inter-component relationships.

17. The non-transitory computer readable storage medium of claim 16, wherein the component comprises one or more solution composition files, wherein the one or more solution composition files comprise:
a directory of one or more logically related resources used in the solution;
a directory storing data that identifies providers of the one or more logically related resources;
a directory of input variables to be defined in the solution;
a directory of output variables to be defined in the solution; and
a directory of data that corresponds to the inter-component relationships.

18. The non-transitory computer readable storage medium of claim 17, wherein generating solution composition recommendations further causes the one or more processors to:
parse the one or more solution composition files comprising metadata associated with the component;
identify a second component within the solution that is logically related to the component; and
recommend that the component and the second component within the solution be connected.

19. The non-transitory computer readable storage medium of claim 17, wherein defining the input variables and the output variables comprises receiving a user command identifying global variables, wherein a global variable has a same user-defined value across all components within the solution.

20. The non-transitory computer readable storage medium of claim 17, wherein defining the input variables and the output variables comprises receiving a user command identifying non-global variables, wherein a non-global variable has a unique user-defined value in each component within the solution.
